(19) United States
(12) Patent Application Publication
(10) Pub. No.: US 2025/0392079 A1
(43) Pub. Date: Dec. 25, 2025

(54) CONNECTOR AND WIRE HARNESS

(71) Applicant: Yazaki Corporation, Tokyo (JP)

(72) Inventors: Tetsuya WATANABE, Shizuoka (JP); Yuuna MATSUBARA, Shizuoka (JP)

(73) Assignee: Yazaki Corporation, Tokyo (JP)

(21) Appl. No.: 19/196,930

(22) Filed: May 2, 2025

(30) Foreign Application Priority Data
Jun. 25, 2024 (JP) 2024-101704

(51) Int. Cl. H01R 13/641; H01R 13/627

(52) U.S. Cl. CPC H01R 13/641; H01R 13/6272

(57) ABSTRACT

A connector includes a terminal, a housing, and a fitting assuring member, a housing lock of the housing includes a lock arm portion, a definitive engagement portion, and a tentative engagement portion, and the fitting assuring member includes a fitting assuring arm portion, a contact portion, a first protruding portion, and a second protruding portion, and the tentative engagement portion is provided with an inclined surface inclined with respect to an axis line direction, by the tentative engagement portion inclining in accordance with elastic deformation of the lock arm portion that is caused when the definitive engagement portion gets over the lock engagement portion.

### CROSS-REFERENCE TO RELATED APPLICATION(S)

The present application claims priority to and incorporates by reference the entire contents of Japanese Patent Application No. 2024-101704 filed in Japan on Jun. 25, 2024.

### BACKGROUND OF THE INVENTION

### 1. Field of the Invention

The present invention relates to a connector and a wire harness.

### 2. Description of the Related Art

As a conventional technique related to a connector of a wire harness, for example, Japanese Patent Application Laid-open No. 2019-67744 discloses a connector including a terminal to be electrically connected with a counterpart terminal of a counterpart connector, a housing including a housing main body that holds the terminal thereinside, and is to be fitted with a counterpart housing of the counterpart connector, and a housing lock to be engaged with a lock engagement portion provided in the counterpart housing, when a fitted state of the housing main body and the counterpart housing is a totally-fitted state, and a fitting assuring member that is assembled to the housing, while being configured to be relatively immovable from a tentative engagement position with respect to the housing when the fitted state is a half-fitted state, is configured to be relatively movable between the tentative engagement position and a definitive engagement position with respect to the housing when the fitted state is the totally-fitted state, and assures the totally-fitted state at the definitive engagement position.

Meantime, the above-described connector described in Japanese Patent Application Laid-open No. 2019-67744 has room for further improvement in terms of enhancement in workability of a fitting work with a counterpart connector, for example.

### SUMMARY OF THE INVENTION

The present invention has been devised in view of the above-described circumstances, and the object of the present invention is to provide a connector and a wire harness that can enhance workability of a fitting work with a counterpart connector.

To achieve the objection, a connector to one aspect of the present invention includes a terminal to be electrically connected with a counterpart terminal of a counterpart connector; a housing including a housing main body that holds the terminal thereinside, and is to be fitted with a counterpart housing of the counterpart connector along an axis line direction, and a housing lock to be engaged with a lock engagement portion provided in the counterpart housing, along the axis line direction when a fitted state of the housing main body and the counterpart housing is a totally-fitted state; and a fitting assuring member that is assembled to the housing, while being configured to be relatively immovable from a tentative engagement position with respect to the housing when the fitted state is a half-fitted state, is configured to be relatively movable along the axis line direction between the tentative engagement position and a definitive engagement position with respect to the housing when the fitted state is the totally-fitted state, and assures the totally-fitted state at the definitive engagement position, wherein the housing lock includes a lock arm portion that extends from the housing main body along the axis line direction and is elastically deformable in a height direction intersecting with the axis line direction, a definitive engagement portion that gets over one end surface in the axis line direction of the lock engagement portion in accordance with a fitting operation of the housing main body provided in the lock arm portion, and the counterpart housing, and is to be engaged with a different end surface in the axis line direction of the lock engagement portion when the fitted state is the totally-fitted state, and a tentative engagement portion provided with being separated from the definitive engagement portion along the axis line direction, the fitting assuring member includes a fitting assuring arm portion protruding in a cantilever spring shape toward the definitive engagement portion, a contact portion that gets contact with the definitive engagement portion in accordance with elastic deformation of the lock arm portion that is caused when the definitive engagement portion provided at a leading end portion of the fitting assuring arm portion gets over the lock engagement portion, and pushes the definitive engagement portion toward the lock engagement portion side by elastic restoring force of the fitting assuring arm portion, a first protruding portion that is provided at the leading end portion of the fitting assuring arm portion and is to be engaged with the definitive engagement portion at the definitive engagement position, and a second protruding portion that is provided with being separated from the first protruding portion along the axis line direction and is to be engaged with the tentative engagement portion at the tentative engagement position, and the tentative engagement portion is provided with an inclined surface inclined with respect to the axis line direction, and the second protruding portion runs onto the inclined surface of the tentative engagement portion by the tentative engagement portion inclining in accordance with elastic deformation of the lock arm portion that is caused when the definitive engagement portion gets over the lock engagement portion, and the fitting assuring member is configured to be able to retract along the axis line direction toward an opposite side to the definitive engagement portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a wire harness to which a connector according to an embodiment is applied;

FIG. 2 is an exemplary exploded perspective view of a connector and a counterpart connector according to an embodiment;

FIG. 3 is an exemplary exploded perspective view of a connector according to an embodiment;

FIG. 4 is an exemplary cross-sectional view of a housing lock of a connector according to an embodiment;

FIG. 5 is an exemplary front view of a connector and a counterpart connector according to an embodiment;

FIG. 6 is a cross-sectional view taken along a line VI-VI in FIG. 5, and is a diagram illustrating a state at an assembly start;

FIG. 7 is a cross-sectional view taken along a line VII-VII in FIG. 5, and is a diagram illustrating a state at an assembly start;

FIG. 8 is an exemplary cross-sectional view of a connector and a counterpart connector according to an embodiment, and is a diagram illustrating a state during assembly at a position corresponding to FIG. 6;

FIG. 9 is an exemplary cross-sectional view of a connector and a counterpart connector according to an embodiment, and is a diagram illustrating a state during assembly at a position corresponding to FIG. 7;

FIG. 10 is an enlarged view of a vicinity of a first protruding portion in FIG. 8;

FIG. 11 is an enlarged view of a vicinity of a second protruding portion in FIG. 9;

FIG. 12 is an exemplary cross-sectional view of a connector and a counterpart connector according to an embodiment, and is a diagram illustrating a state of assembly completion at a position corresponding to FIG. 6, and a tentative engagement position;

FIG. 13 is an exemplary cross-sectional view of a connector and a counterpart connector according to an embodiment, and is a diagram illustrating a state of assembly completion at a position different from FIG. 12, and a tentative engagement position;

FIG. 14 is an exemplary cross-sectional view of a connector and a counterpart connector according to an embodiment, and is a diagram illustrating a state of assembly completion at a position corresponding to FIG. 6, and a definitive engagement position; and

FIG. 15 is an exemplary cross-sectional view of a connector and a counterpart connector according to an embodiment, and is a diagram illustrating a state of assembly completion at a position different from FIG. 14, and a definitive engagement position.

### DETAILED DESCRIPTION OF THE PREFERRED EMBODIMENTS

An embodiment according to the present invention will be described in detail below based on the drawings. In addition, the present invention is not limited by the following embodiment. Further, components in the following embodiment include the ones that can be replaced by those skilled in the art, and are easy, or the ones that are substantially identical. In addition, in this specification, ordinal numbers are used only to distinguish parts, members, regions, positions, directions, and the like, and do not indicate order or priority.

### Embodiment

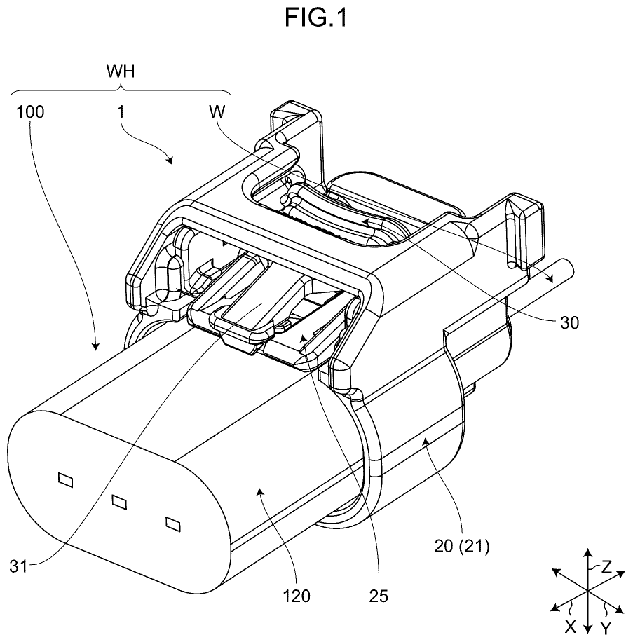

FIG. 1 is a perspective view of a wire harness WH to which a connector 1 according to an embodiment is applied. The connector 1 of the present embodiment illustrated in FIG. 1 is incorporated into the wire harness WH laid in a vehicle such as an automobile. Here, the wire harness WH bundles, as a set of components, wiring materials W to be used for power supply and signal communication, for connection between devices mounted on the vehicle, for example, and connects the wiring materials W to the devices via the connector 1 or the like. The wire harness WH of the present embodiment includes a plurality of wiring materials W having electrical conductivity, the connector 1 provided at the end of the plurality of wiring materials W, and a counterpart connector 100 to be electrically and mechanically connected with the connector 1. In addition, aside from this, the wire harness WH may further include various component parts such as a grommet, a protector, and a fixing tool.

Note that, in the following description, among a first direction, a second direction, and a third direction that intersect with each other, the first direction will be referred to as an “axis line direction X”, the second direction will be referred to as a “width direction Y”, and the third direction will be referred to as a “height direction Z”. Here, the axis line direction X, the width direction Y, and the height direction Z are approximately orthogonal to each other. Typically, the axis line direction X extends along an extending direction of the wiring materials W, a fitting direction (insertion direction) of the connector 1 and the counterpart connector 100, and the like. Typically, the width direction Y extends along a radial direction of the wiring materials W, a width direction of the connector 1 and the counterpart connector 100, and the like. Typically, the height direction Z extends along the radial direction of the wiring materials W, a height direction (up-down direction) of the connector 1 and the counterpart connector 100, and the like. Further, each direction to be used in the following description will be described as a direction set in a state in which the connector 1 and the counterpart connector 100 are assembled to a vehicle, unless otherwise stated.

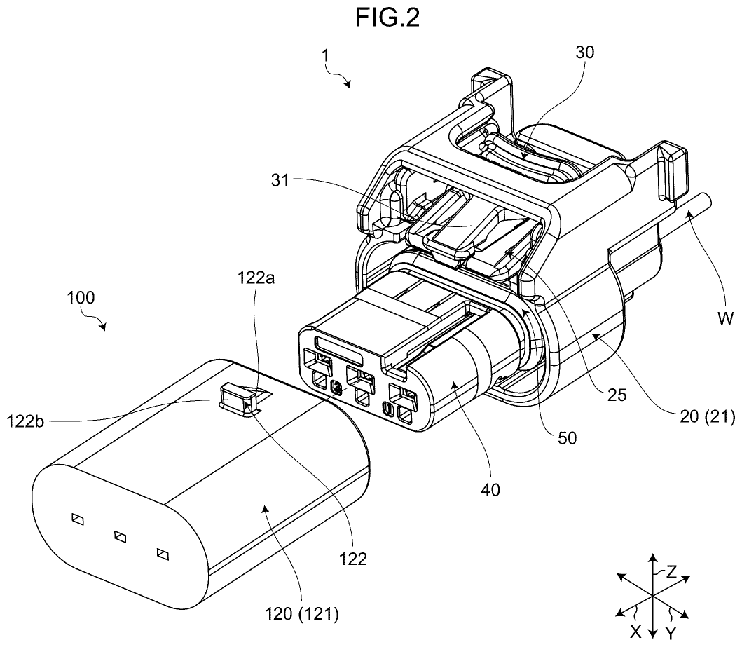

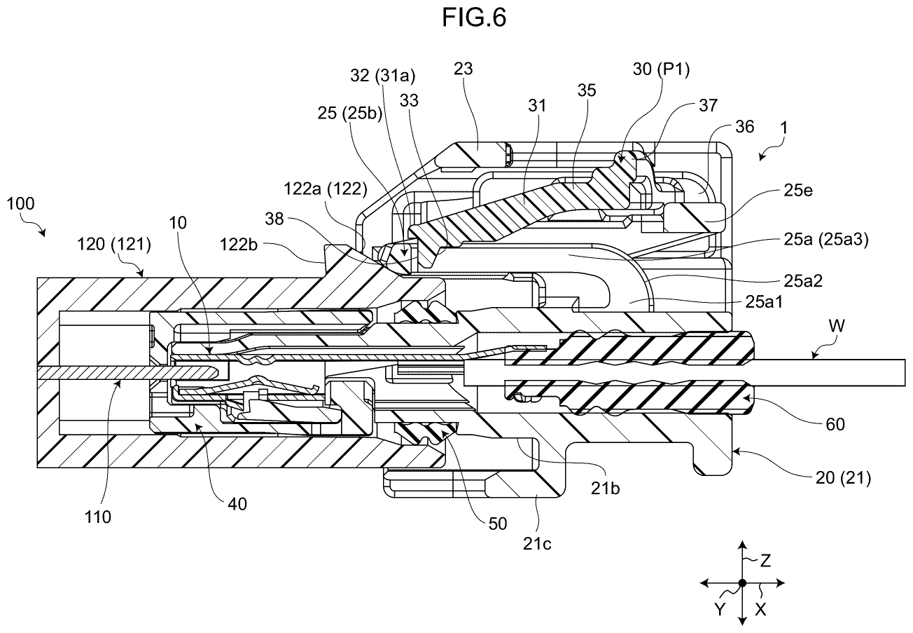

FIG. 2 is an exploded perspective view of, the connector 1 and the counterpart connector 100. As illustrated in FIG. 2, the counterpart connector 100 includes, for example, a counterpart housing 120 and a counterpart terminal 110 (refer to FIG. 6) provided inside the counterpart housing 120. The counterpart terminal 110 is a terminal fitting of a male die made of a metal material having electrical conductivity, for example, and is electrically connected with a terminal 10 of the connector 1. The counterpart terminal 110 includes, for example, an electrical connection portion to be electrically connected with the terminal 10, and a wire crimping portion to be electrically connected with the end of a wire (not illustrated).

The counterpart housing 120 holds the counterpart terminal 110 and the like thereinside. The counterpart housing 120 includes, for example, a counterpart housing main body 121, and a lock engagement portion 122 protruding from the counterpart housing main body 121 along the height direction Z. The counterpart housing main body 121 is formed into a cylindrical shape following the outer circumferential surface of a packing 50 of the connector 1 to be described below, for example. A counterpart terminal accommodation chamber extending along the axis line direction X, into which the counterpart terminal 110 is to be accommodated is provided inside the counterpart housing main body 121. In the counterpart housing 120, the counterpart housing main body 121 and the lock engagement portion 122 are integrally formed of a resin material having an insulation property, for example.

The lock engagement portion 122 is a portion to be engaged with a housing lock 25 of the connector 1 to be described below, along the axis line direction X. The lock engagement portion 122 is formed into a tab shape on the outer circumferential surface of the counterpart housing main body 121, for example. The lock engagement portion 122 has a one end surface 122a positioned on one end portion side (the connector 1 side) in the axis line direction X, and a different end surface 122b positioned on a different end portion side in the axis line direction X. In the present embodiment, the one end surface 122a is inclined with respect to the axis line direction X. Specifically, the one end surface 122a is inclined in such a manner as to gradually get away from the outer circumferential surface of the counterpart housing main body 121 along the height direction Z, from the one end portion side in the axis line direction X toward the different end portion side (opposite side to the connector 1), for example. The one end surface 122a is formed as an inclined surface that the housing lock 25 of the connector 1 gets over in accordance with a fitting operation of the connector 1 and the counterpart connector 100.

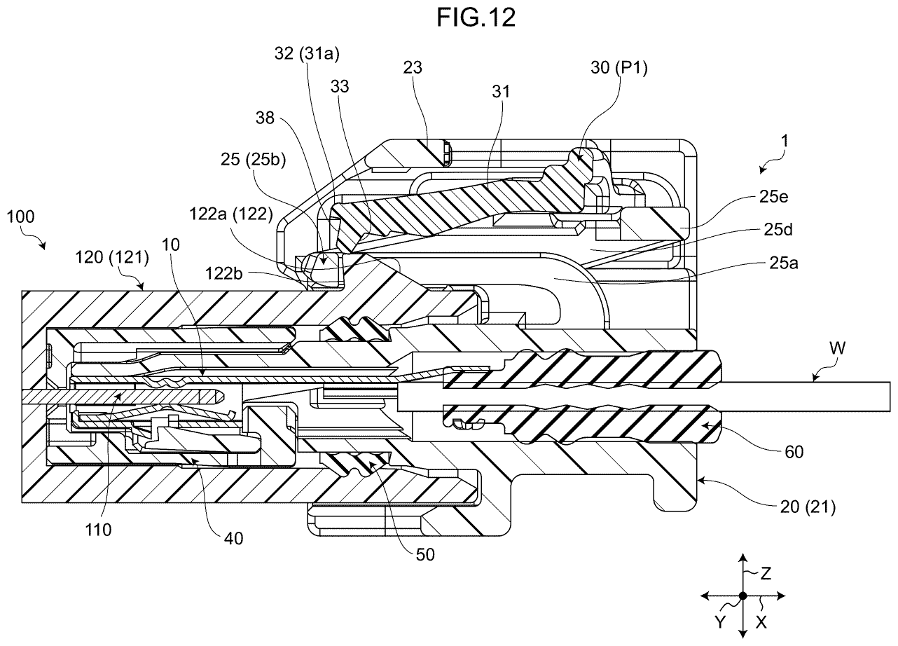

The different end surface 122b is formed into a flat surface extending along the height direction z, for example. The different end surface 122b is engaged with the housing lock 25 along the axis line direction X when a fitted state of the connector 1 and the counterpart connector 100 is a totally-fitted state (refer to FIG. 12) to be described below (i.e., when the housing lock 25 has got over the lock engagement portion 122). In the present embodiment, by the engagement between the different end surface 122b and the housing lock 25, the movement of the connector 1 along the axis line direction X with respect to the counterpart connector 100 is restricted, and the totally-fitted state of the connector 1 and the counterpart connector 100 is held.

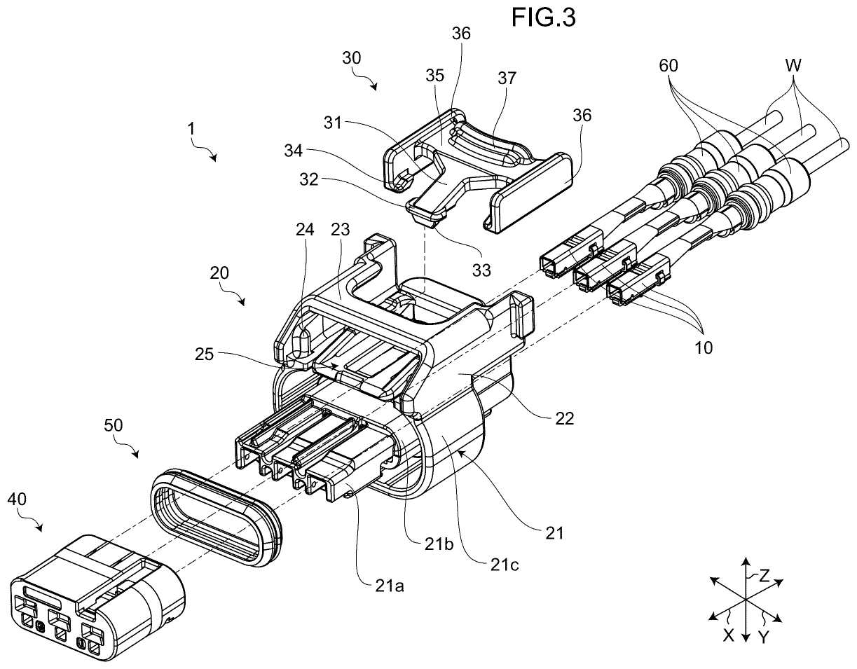

FIG. 3 is an exploded perspective view of the connector 1. As illustrated in FIG. 3, the connector 1 includes, for example, the terminal 10, a housing 20, a fitting assuring member 30, a retainer 40, the packing 50, and a wire seal 60. The terminal 10 is a terminal fitting of a female die made of a metal material having electrical conductivity, for example, and is electrically connected with the above-described counterpart terminal 110. The terminal 10 includes, for example, an electrical connection portion to be electrically connected with the counterpart terminal 110, and a wire crimping portion to be electrically connected with the end of the wiring material W. The terminal 10 will also be referred to as a crimping terminal or the like.

The wiring materials W each include, for example, a linear conductor portion having electrical conductivity, and an insulating coating portion having an insulating property that covers the external side of the conductor portion. The wiring material W is an electrical insulated wire in which the conductor portion is covered with the insulating coating portion. In addition, the conductor portion of the present embodiment is a core wire obtained by a bundling a plurality of metal wires having electrical conductivity, but may be a twisted core wire obtained by twisting the plurality of metal wires together. The insulating coating portion is a wire covering that covers the outer circumferential side of the conductor portion. The insulating coating portion is formed by extrusion-molding an insulating resin material, or the like, for example.

The wiring materials W extend linearly along the axis line direction X, and are formed in such a manner as to extend with almost the same diameter in the axis line direction X (extending direction). Further, each of the wiring materials W is formed in such a manner that a cross-sectional shape of the conductor portion (cross-sectional shape intersecting with the axis line direction X) is an approximately round shape, and a cross-sectional shape of the insulating coating portion is an approximately annular shape, for example, and is formed in into an approximately round shape as a whole. In at least one end of each wiring material W, the insulating coating portion is stripped off, and the terminal 10 is crimped to the conductor portion exposed from the insulating coating portion. The wiring material W will also be referred to as a terminal-equipped wire or the like.

The housing 20 holds the terminal 10, the wiring materials W, the wire seal 60, and the like thereinside. The housing 20 includes, for example, a housing main body 21, a pair of protection walls 22 protruding from the housing main body 21 along the height direction, a coupling wall 23 coupling the pair of protection walls 22, and the housing lock 25 provided to be elastically deformable along the height direction Z with respect to the housing main body 21. In the housing 20, the housing main body 21, the pair of protection walls 22, the coupling wall 23, and the housing lock 25 are integrally formed of a resin material having an insulation property, for example.

The housing main body 21 includes, for example, a plurality of terminal accommodation portions 21a, an inner cylinder portion 21b, and an outer cylinder portion 21c. The plurality of terminal accommodation portions 21a each extend along the axis line direction X, and accommodate the terminal 10 thereinside. In the present embodiment, in the housing main body 21, three terminal accommodation portions 21a are provided side by side along the width direction Y. The terminal accommodation portions 21a neighboring in the width direction Y are coupled. Further, each of the terminal accommodation portions 21a is formed into an approximately rectangular cylindrical shape following an external form of the terminal 10, and protrudes from the inner cylinder portion 21b along the axis line direction X.

The inner cylinder portion 21b covers the outer circumferential sides of the plurality of terminal accommodation portions 21a, and is coupled with the plurality of terminal accommodation portions 21a. The inner cylinder portion 21b is formed into a cylindrical shape following the inner circumferential surface of the packing 50, for example. The outer cylinder portion 21c covers the outer circumferential side of the inner cylinder portion 21b, and formed concentrically with the inner cylinder portion 21b. In the present embodiment, a fitting recess portion into which the counterpart housing 120 of the above-described counterpart connector 100 is to be fitted is provided between the outer cylinder portion 21c and the inner cylinder portion 21b. The outer cylinder portion 21c is formed into an approximately cylindrical shape following the outer circumferential surface of the counterpart housing 120, for example. In addition, in the outer cylinder portion 21c, a cutout portion for forming the housing lock 25 to be described below is provided in a portion between the pair of protection walls 22, for example.

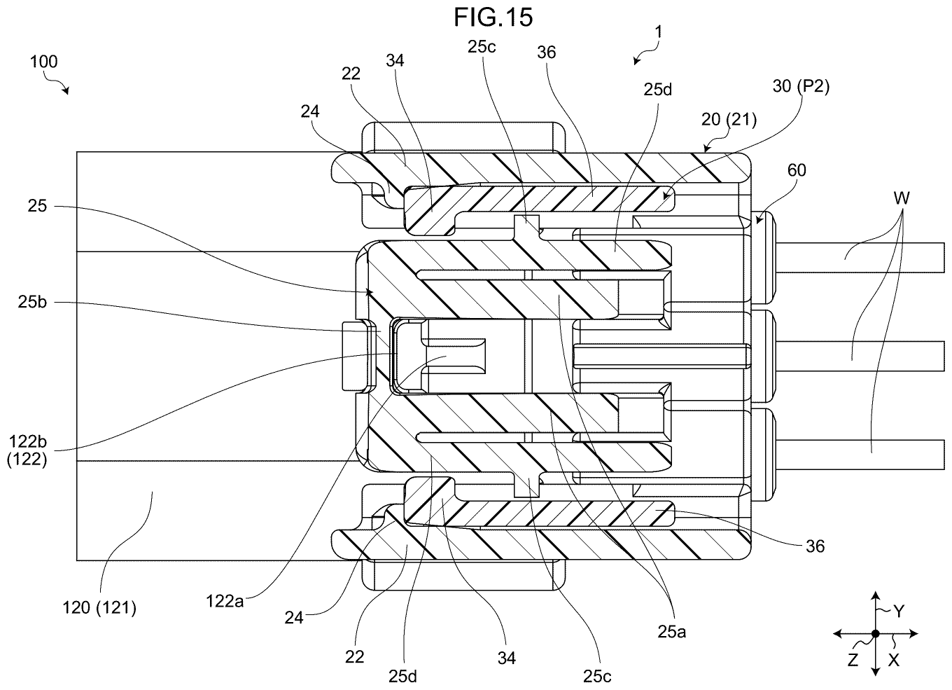

The pair of protection walls 22 cover the housing lock 25 and the fitting assuring member 30 from both sides in the width direction Y. The pair of protection walls 22 protrude from both end portions in the width direction Y of the outer cylinder portion 21c along the height direction Z, and extend along the axis line direction X, for example. On the inner surfaces of the pair of protection walls 22, stopper portions 24 to be engaged with the fitting assuring member 30 along the axis line direction X in a state in which the fitting assuring member 30 is at a definitive engagement position P2 (refer to FIG. 15) to be described below is provided. The stopper portions 24 are provided on the different end portion side (the counterpart connector 100 side) in the axis line direction X of the pair of protection walls 22, and protrude from the pair of protection walls 22 along the width direction Y toward a side getting closer to each other, for example.

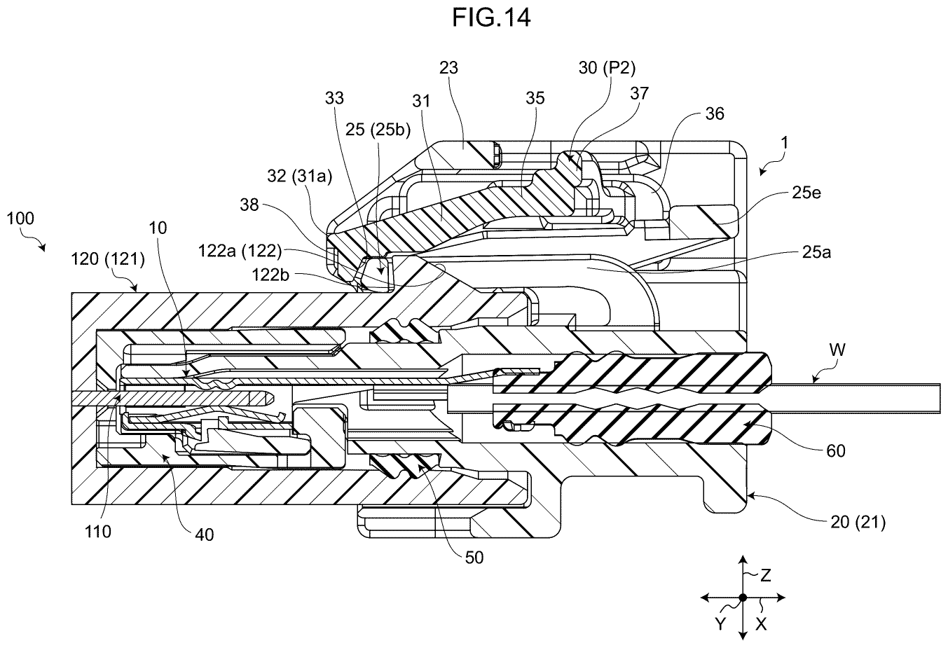

The coupling wall 23 (refer to FIG. 3) couples one end portions (upper end portions) in the height direction Z of the pair of protection walls 22. The coupling wall 23 is provided, for example, on the different end portion side in the axis line direction X of the pair of protection walls 22, and extends along the width direction Y in such a manner as to cross between the pair of protection walls 22. In the present embodiment, an insertion space portion into which the fitting assuring member 30 is inserted is provided between the pair of protection walls 22, the coupling wall 23, and the inner cylinder portion 21b. The coupling wall 23 covers the fitting assuring member 30 from one end portion side (upper side) in the height direction z in a state in which the fitting assuring member 30 is at the definitive engagement position P2 (refer to FIG. 14) and a tentative engagement position P1 (refer to FIG. 6) to be described below. Further, the housing lock 25 to be described below is provided between the pair of protection walls 22 on the outer circumferential surface of the inner cylinder portion 21b.

The fitting assuring member 30 is a member for causing a user to determine whether a fitted state of the housing 20 (the housing main body 21) and the counterpart housing 120 is the totally-fitted state or a half-fitted state, and assuring the totally-fitted state if the fitted state is the totally-fitted state. The fitting assuring member 30 is assembled to the housing 20, and is configured to be relatively immovable from the tentative engagement position P1 (refer to FIGS. 6, 8, and 12) with respect to the housing 20 when a fitted state of the housing 20 and the counterpart housing 120 is the half-fitted state. On the other hand, the fitting assuring member 30 is configured to be relatively movable along the axis line direction X between the tentative engagement position P1 (refer to FIG. 12) and the definitive engagement position P2 (refer to FIG. 14) with respect to the housing 20 when a fitted state of the housing 20 and the counterpart housing 120 is the totally-fitted state.

Accordingly, the fitting assuring member 30 can cause a user to recognize whether a fitted state of the housing 20 and the counterpart housing 120 is the totally-fitted state or the half-fitted state, depending on whether a current state is a state in which the fitting assuring member 30 is at the tentative engagement position P1 or a state in which the fitting assuring member 30 is at the definitive engagement position P2 with respect to the housing 20. Then, the fitting assuring member 30 assures that a fitted state of the housing 20 and the counterpart housing 120 is the totally-fitted state in a state in which the fitting assuring member 30 is at the definitive engagement position P2 with respect to the housing 20.

The plurality of terminal accommodation portions 21a is inserted into the retainer 40 (refer to FIG. 3), and the retainer 40 holds the terminal 10 in each of the terminal accommodation portions 21a. The retainer 40 is provided with an insertion hole into which each of the terminal accommodation portions 21a is inserted along the axis line direction X, and a through-hole communicated with the insertion hole, into which the counterpart terminal 110 of the counterpart connector 100 is inserted along the axis line direction X. The retainer 40 is formed of a resin material having insulation.

The packing 50 prevents a foreign substance such as moisture from entering the housing 20. The packing 50 is formed of elastically-deformable members such as rubber or resin. The packing 50 is formed into a cylindrical shape following the outer circumferential surface of the above-described inner cylinder portion 21b, for example, and fitted with the outer circumferential surface of the inner cylinder portion 21b. In a state in which the housing 20 and the counterpart housing 120 are fitted, the packing 50 is interposed between the outer circumferential surface of the inner cylinder portion 21b and the inner circumferential surface of the counterpart housing 120 (refer to FIG. 6).

The wire seal 60 prevents a foreign substance such as moisture from entering the housing 20. The wire seal 60 is formed of elastically-deformable members such as rubber or resin. The wire seal 60 is formed into a cylindrical shape following the outer circumferential surface of the wiring material W, for example, and fitted with the outer circumferential surface of the wiring material W. In a state in which the wiring material W is attached to the inside of the housing 20, the wire seal 60 is interposed between the outer circumferential surface of the wiring material W and the inner circumferential surface of the inner cylinder portion 21b (refer to FIG. 6).

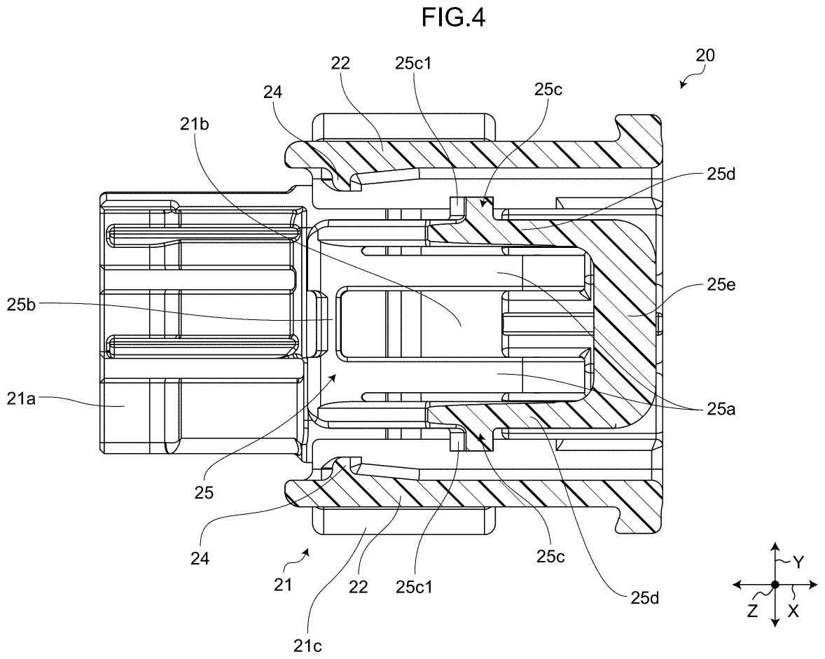

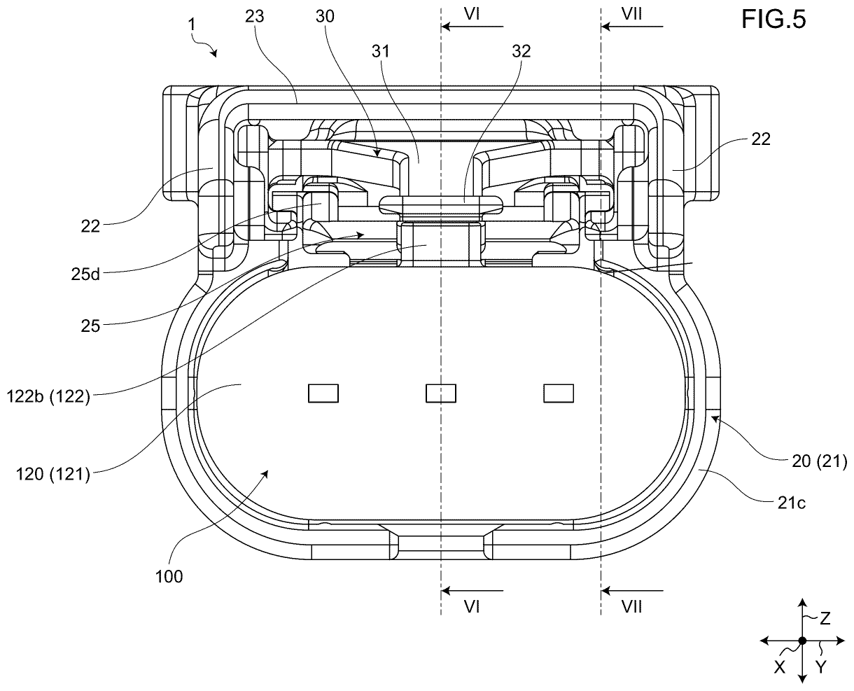

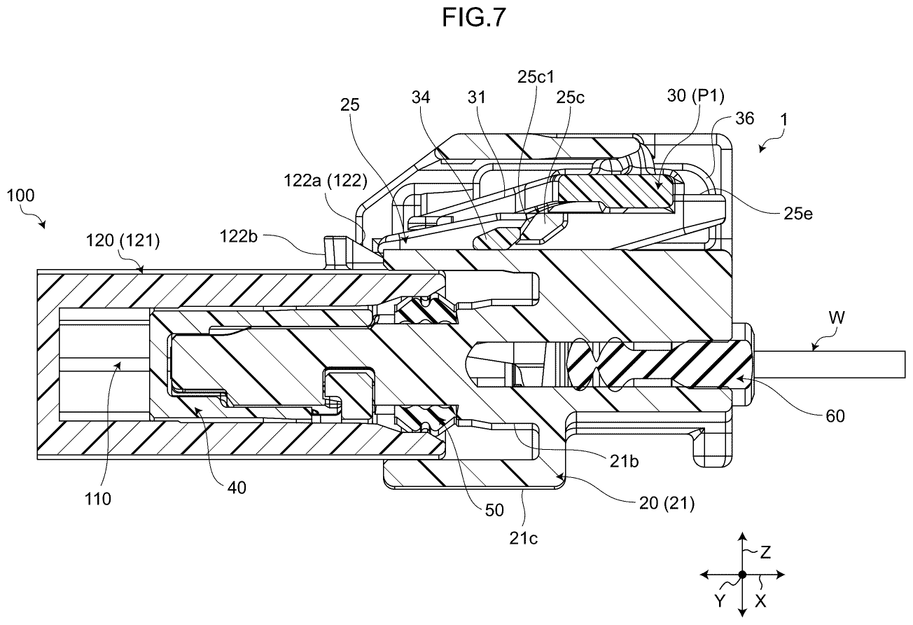

FIG. 4 is a cross-sectional view of the housing lock 25 of the connector 1, FIG. 5 is a front view of the connector 1 and the counterpart connector 100, FIG. 6 is a cross-sectional view taken along a line VI-VI in FIG. 5, and is a diagram illustrating a state at an assembly start (fitting start), and FIG. 7 is a cross-sectional view taken along a line VII-VII in FIG. 5, and is a diagram illustrating a state at an assembly start (fitting start). As illustrated in FIGS. 4 to 7, the housing lock 25 includes, for example, a lock arm portion 25a, a definitive engagement portion 25b, a tentative engagement portion 25c, a folded-back arm portion 25d, and an unlock operation portion 25e.

The lock arm portion 25a (refer to FIG. 6) is a portion of the housing lock 25 that is formed into a cantilever spring shape, and formed to be elastically deformable along the height direction Z. The lock arm portion 25a includes, for example, a proximal end portion 25al (fulcrum point portion) protruding from the outer circumferential surface of the inner cylinder portion 21b along the height direction z, and a leading end portion 25a3 connected with the proximal end portion 25al via a curved portion 25a2 and extending along the axis line direction X. In the present embodiment, in the housing lock 25, a pair of lock arm portions 25a (refer to FIG. 4) are provided at an interval in the width direction Y.

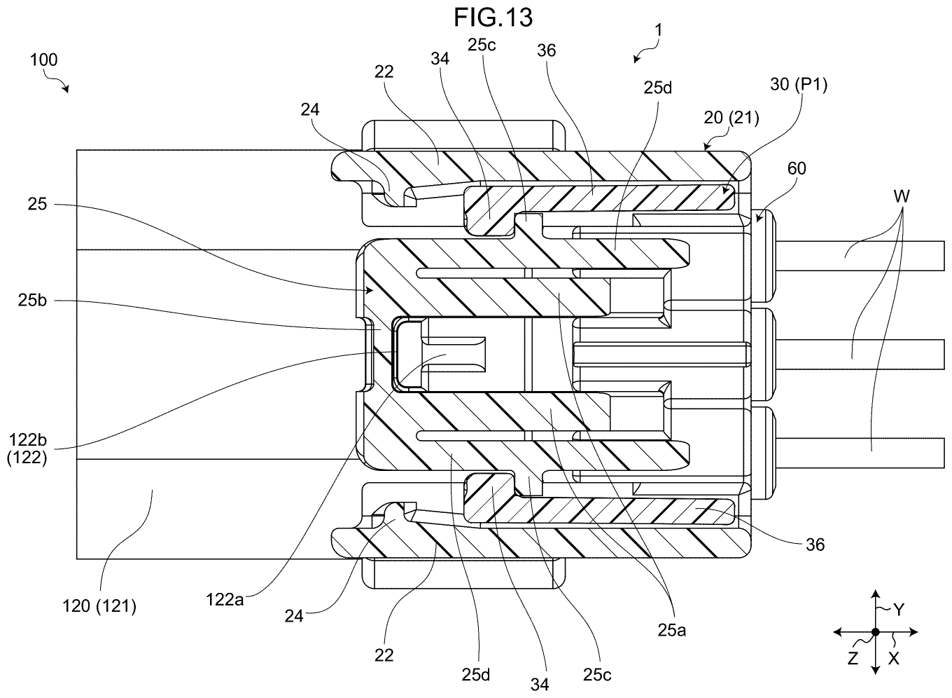

The definitive engagement portion 25b is a portion of the housing lock 25 that extends along the width direction Y, and couples the leading end portions 25a3 being free ends of the pair of lock arm portions 25a. The definitive engagement portion 25b gets over the one end surface 122a (inclined surface) in the axis line direction X of the above-described lock engagement portion 122 (refer to FIG. 6) in accordance with a fitting operation of the housing 20 and the counterpart housing 120. Then, when a fitted state of the housing 20 and the counterpart housing 120 is the totally-fitted state (refer to FIG. 12), the definitive engagement portion 25b returns to a free state and is engaged with the different end surface 122b in the axis line direction X of the lock engagement portion 122. In this state, the lock engagement portion 122 is engaged between the pair of lock arm portions 25a (refer to FIG. 13). Further, the definitive engagement portion 25b is engaged with a first protruding portion 33 of the fitting assuring member 30 in a state in which the fitting assuring member 30 is at the definitive engagement position P2 (refer to FIG. 14).

The folded-back arm portion 25d is a portion of the housing lock 25 in which a part of the lock arm portion 25a is folded back along the axis line direction X from both end portions in the width direction Y of the definitive engagement portion 25b. In the present embodiment, in the housing lock 25, a pair of folded-back arm portions 25d (refer to FIG. 4) are provided at an interval in the width direction Y. The pair of folded-back arm portions 25d are positioned between the pair of lock arm portions 25a and the pair of protection walls 22 in the width direction Y. In the present embodiment, the pair of folded-back arm portions 25d are inclined with respect to the axis line direction X. Specifically, the pair of folded-back arm portions 25d are inclined in such a manner as to gradually get away from the outer circumferential surface of the inner cylinder portion 21b along the height direction z toward one end portion side (the unlock operation portion 25e side) in the axis line direction X, for example.

The tentative engagement portion 25c is a portion of the housing lock 25 that is engaged with a second protruding portion 34 of the fitting assuring member 30 in a state in which the fitting assuring member 30 is at the tentative engagement position P1 (refer to FIG. 7). The tentative engagement portions 25c (refer to FIG. 4) are provided at approximately central parts in the axis line direction X of the pair of folded-back arm portions 25d, for example, and protrude from the pair of folded-back arm portions 25d toward a side mutually getting away from each other along the width direction Y. That is, the tentative engagement portions 25c are positioned between the pair of lock arm portions 25a and the pair of protection walls 22 in the width direction Y. Further, the tentative engagement portions 25c are positioned with being separated from the definitive engagement portion 25b along the axis line direction X.

In the present embodiment, the tentative engagement portion 25c is provided with an inclined surface 25cl inclined with respect to the axis line direction X. The inclined surface 25cl is provided on an end surface on a different end portion side (the second protruding portion 34 side) in the axis line direction X of the tentative engagement portion 25c, and engaged with the second protruding portion 34 (refer to FIG. 7). The inclined surface 25cl is inclined in such a manner as to gradually get away from the outer circumferential surface of the housing main body 21 (the inner cylinder portion 21b or the outer cylinder portion 21c) along the height direction z from the different end portion side in the axis line direction X toward one end portion side (the opposite side to the second protruding portion 34), for example.

The unlock operation portion 25e is a portion of the housing lock 25 that is to be used as an operation portion for cancelling an engaged state (refer to FIG. 12) of the above-described definitive engagement portion 25b and the lock engagement portion 122. The unlock operation portion 25e extends along the width direction Y and couples one end portions in the axis line direction X of the pair of folded-back arm portions 25d. By the unlock operation portion 25e being pushed in along the height direction z toward a side of getting closer to the outer circumferential surface of the inner cylinder portion 21b (the housing main body 21), for example, a different end portion side in the axis line direction X of the pair of folded-back arm portions 25d (i.e., the definitive engagement portion 25b side) is lifted up toward a side of getting away from the lock engagement portion 122 along the height direction Z. This can cancel the engaged state of the definitive engagement portion 25b and the lock engagement portion 122.

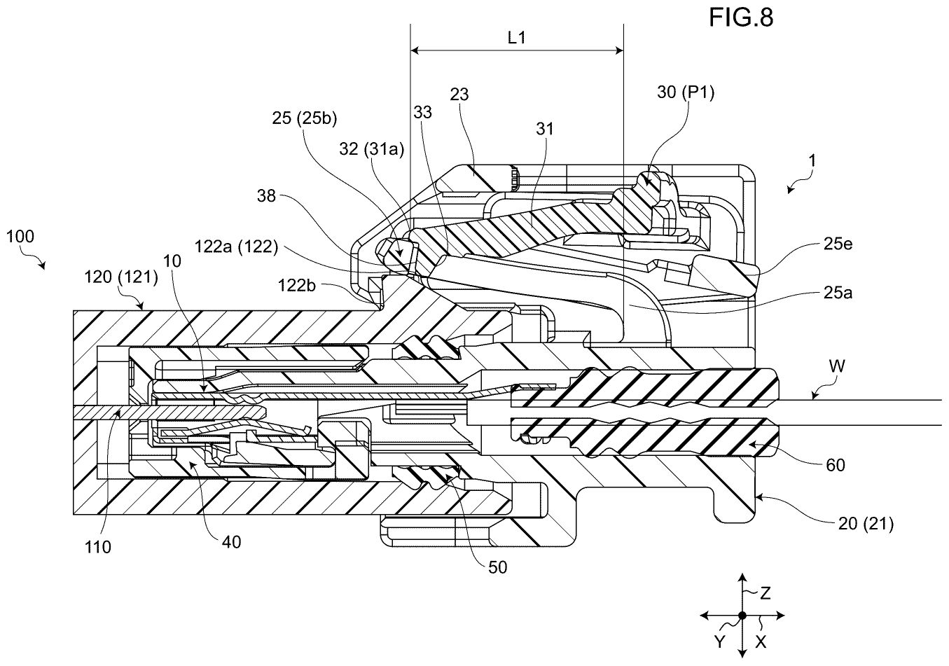

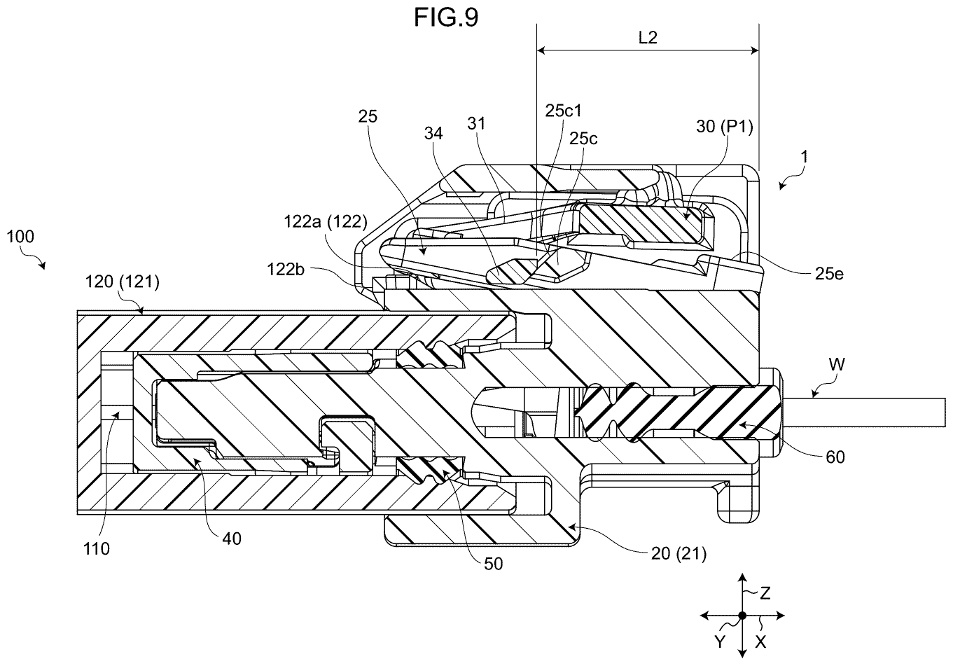

FIG. 8 is a cross-sectional view of the connector 1 and the counterpart connector 100, and is a diagram illustrating a state during assembly at a position corresponding to FIG. 6, and FIG. 9 is a cross-sectional view of the connector 1 and the counterpart connector 100, and is a diagram illustrating a state during assembly at a position corresponding to FIG. 7. As illustrated in FIGS. 3, 8, and 9, the fitting assuring member 30 includes, for example, a fitting assuring arm portion 31, a contact portion 32, the first protruding portion 33, the second protruding portion 34, a coupling portion 35, a pair of side wall portions 36, and an operation portion 37. In the fitting assuring member 30, the fitting assuring arm portion 31, the contact portion 32, the first protruding portion 33, the second protruding portion 34, the coupling portion 35, the pair of side wall portions 36, and the operation portion 37 are integrally formed of a synthetic resin material having flexibility or the like, for example.

The coupling portion 35 and the pair of side wall portions 36 are portions of the fitting assuring member 30 that are included in a main body portion of the fitting assuring member 30. The pair of side wall portions 36 are provided at an interval along the width direction Y, for example, and extends along the axis line direction X. The pair of side wall portions 36 are inserted into the inner side of the above-described pair of protection walls 22. The coupling portion 35 couples the pair of side wall portions 36. The coupling portion 35 is provided, for example, on the one end portion side in the axis line direction X of the pair of side wall portions 36, and extends along the width direction Y in such a manner as to cross between the pair of side wall portions 36.

The fitting assuring arm portion 31 is a portion of the fitting assuring member 30 that protrudes in a cantilever spring shape from the coupling portion 35 included in the main body portion, toward the definitive engagement portion 25b of the housing lock 25. The fitting assuring arm portion 31 is inclined with respect to the axis line direction X in a free state (refer to FIG. 6) in which the fitting assuring member 30 is at the tentative engagement position P1, and before the fitting assuring arm portion 31 elastically deforms in accordance with elastic deformation of the lock arm portion 25a, for example. Specifically, the fitting assuring arm portion 31 is inclined in such a manner as to gradually get away from the outer circumferential surface of the counterpart housing 120 along the height direction Z from a different end portion side (the definitive engagement portion 25b side) in the axis line direction X toward one end portion side.

The contact portion 32 is a portion that is provided at a leading end portion 31a of the fitting assuring arm portion 31, and gets contact with the definitive engagement portion 25b in accordance with elastic deformation of the lock arm portion 25a that is caused when the definitive engagement portion 25b gets over the lock engagement portion 122. The contact portion 32 is provided on a different end surface (leading end surface) in the axis line direction X of the fitting assuring arm portion 31, for example, and protrudes from the different end surface along the axis line direction X. In a state (refer to FIG. 8) in which the contact portion 32 has contact with the definitive engagement portion 25b in accordance with elastic deformation of the lock arm portion 25a, the contact portion 32 pushes the definitive engagement portion 25b toward the lock engagement portion 122 side by elastic restoring force of the fitting assuring arm portion 31.

The first protruding portion 33 is a portion that is provided at the leading end portion 31a of the fitting assuring arm portion 31, and is engaged with the definitive engagement portion 25b in a state in which the fitting assuring member 30 is at the definitive engagement position P2 (refer to FIG. 14). The first protruding portion 33 protrudes from the fitting assuring arm portion 31 toward the lock engagement portion 122 side along the height direction Z. In a state in which the fitting assuring member 30 is at the definitive engagement position P2, the first protruding portion 33 is positioned on the different end portion side in the axis line direction X with respect to the definitive engagement portion 25b, and sandwiches the definitive engagement portion 25b between itself and the lock engagement portion 122.

Further, a recess portion 38 is provided between the first protruding portion 33 and the contact portion 32. The recess portion 38 is a portion that is engaged with the definitive engagement portion 25b (refer to FIG. 8) in accordance with elastic deformation of the lock arm portion 25a that is caused when the definitive engagement portion 25b gets over the lock engagement portion 122. The recess portion 38 is provided on the different end surface (leading end surface) in the axis line direction X of the fitting assuring arm portion 31, and is recessed from the different end surface toward one end portion side in the axis line direction X. In a state in which the fitting assuring member 30 is at the tentative engagement position P1, and before the fitting assuring arm portion 31 elastically deforms in accordance with elastic deformation of the lock arm portion 25a, for example, the recess portion 38 is positioned with being separated from the definitive engagement portion 25b along the axis line direction X.

The second protruding portion 34 is a portion to be engaged with the inclined surface 25cl of the tentative engagement portion 25c in a state in which the fitting assuring member 30 is at the tentative engagement position P1 (refer to FIG. 9). The second protruding portion 34 is provided on the different end portion side in the axis line direction X of the pair of side wall portions 36 (refer to FIG. 3), for example, and protrudes from the pair of side wall portions 36 along the width direction Y toward a side getting closer to each other. That is, the second protruding portions 34 are provided on inner surfaces of the pair of side wall portions 36. Further, the second protruding portion 34 is positioned with being separated from the first protruding portion 33 along the axis line direction X.

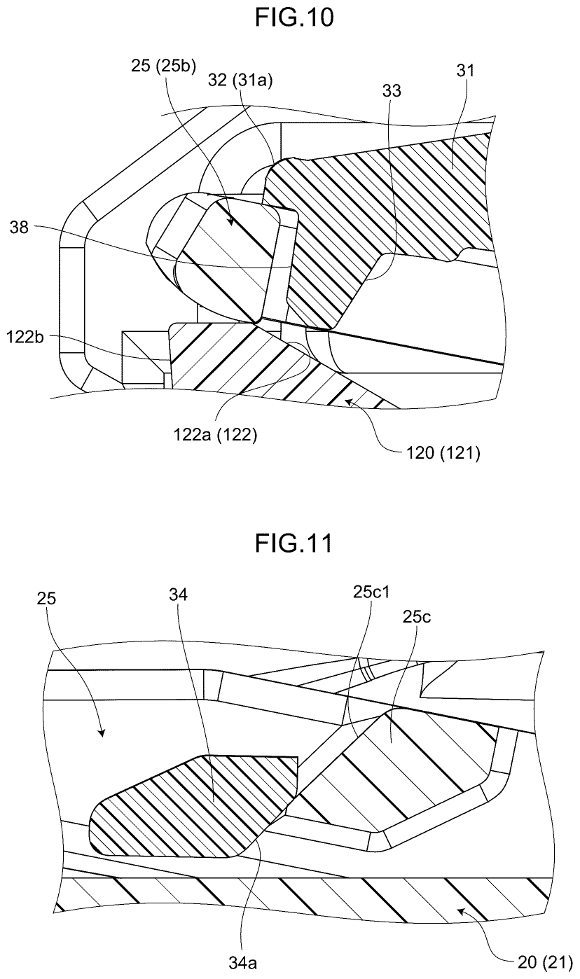

FIG. 10 is an enlarged view of a vicinity of the first protruding portion 33 in FIG. 8, and FIG. 11 is an enlarged view of a vicinity of the second protruding portion 34 in FIG. 9. As illustrated in FIGS. 10 and 11, in the present embodiment, by the tentative engagement portion 25c inclining in accordance with elastic deformation of the lock arm portion 25a that is caused when the definitive engagement portion 25b gets over the lock engagement portion 122, the second protruding portion 34 is configured to be able to run onto the inclined surface 25cl of the tentative engagement portion 25c. An engagement position of a one end portion 34a in the axis line direction X of the second protruding portion 34 with respect to the inclined surface 25cl of the tentative engagement portion 25c accordingly lowers, and the fitting assuring member 30 retracts along the axis line direction X toward the opposite side to the definitive engagement portion 25b.

In the present embodiment, the fitting assuring member 30 is configured to retract in a state in which the definitive engagement portion 25b has started to run onto one end portion in the axis line direction X of the one end surface 122a (inclined surface) of the lock engagement portion 122, or in any section between the state and a state (refer to FIG. 10) in which the definitive engagement portion 25b has shifted up to a different end portion (vertex portion) in the axis line direction X of the one end surface 122a. In a state in which the fitting assuring member 30 has retracted with respect to the definitive engagement portion 25b, a clearance gap extending along the axis line direction X is formed between the first protruding portion 33 and the definitive engagement portion 25b. That is, in a state in which the fitting assuring member 30 is at the tentative engagement position P1 and the lock arm portion 25a is elastically deformed, the definitive engagement portion 25b is positioned in the recess portion 38 with being separated from the first protruding portion 33 along the axis line direction X.

In this manner, in the present embodiment, by the fitting assuring member 30 retracting, a distance L1 (refer to FIG. 8) along the axis line direction X from the proximal end portion 25al (fulcrum point portion) of the lock arm portion 25a up to the contact portion 32 becomes shorter. This can reduce elastic restoring force (reactive force) of the fitting assuring arm portion 31 that acts on the definitive engagement portion 25b from the contact portion 32, and eventually reduce elastic restoring force (reactive force) of the lock arm portion 25a that acts on the lock engagement portion 122 from the definitive engagement portion 25b. Further, in the present embodiment, by the fitting assuring member 30 retracting, the engagement position of the one end portion 34a in the axis line direction X of the second protruding portion 34 with respect to the inclined surface 25cl of the above-described tentative engagement portion 25c lowers. Accordingly, a distance L2 (refer to FIG. 9) along the axis line direction X from the second protruding portion 34 up to one end portion (rear end portion) in the axis line direction of the housing 20 also becomes shorter.

FIG. 12 is a cross-sectional view of the connector 1 and the counterpart connector 100, and is a diagram illustrating a state of assembly completion (fitting completion) at a position corresponding to FIG. 6, and the tentative engagement position P1, and FIG. 13 is an exemplary cross-sectional view of the connector 1 and the counterpart connector 100, and is a diagram illustrating a state of assembly completion (fitting completion) at a position different from FIG. 12, and the tentative engagement position P1. Further, FIG. 14 is a cross-sectional view of the connector 1 and the counterpart connector 100, and is a diagram illustrating a state of assembly completion (fitting completion) at a position corresponding to FIG. 6, and the definitive engagement position P2, and FIG. 15 is an exemplary cross-sectional view of the connector 1 and the counterpart connector 100, and is a diagram illustrating a state of assembly completion (fitting completion) at a position different from FIG. 14, and the definitive engagement position P2.

As illustrated in FIGS. 12 to 15, in the present embodiment, when a fitted state of the housing 20 and the counterpart housing 120 is the totally-fitted state (i.e., in a state caused after the definitive engagement portion 25b has got over the lock engagement portion 122 (refer to FIG. 12), an engaged state of the first protruding portion 33 and the definitive engagement portion 25b is cancelled. Accordingly, the fitting assuring member 30 becomes relatively movable along the axis line direction X between the tentative engagement position P1 (refer to FIG. 12) and the definitive engagement position P2 (refer to FIG. 14) with respect to the housing 20. Specifically, the fitting assuring member 30 is configured to be relatively movable along the axis line direction X within a range between the above-described tentative engagement portion 25c (refer to FIG. 13) provided in the housing lock 25, and the above-described stopper portions 24 (refer to FIG. 15) provided on the pair of protection walls 22.

At this time, in the present embodiment, for example, the operation portion 37 (refer to FIG. 14) of the fitting assuring member 30 is operated. The operation portion 37 is a portion used as an operation portion for moving the fitting assuring member 30 between the tentative engagement position P1 and the definitive engagement position P2 along the axis line direction X. The operation portion 37 protrudes along the height direction Z from the coupling portion 35 included in the main body portion, for example, and extends along the width direction Y. A worker can move the fitting assuring member 30 from the tentative engagement position P1 to the definitive engagement position P2 by pushing the operation portion 37 toward the different end portion side (the counterpart connector 100 side) in the axis line direction X in a state in which the operation portion 37 is pinched, for example. Further, a worker can move the fitting assuring member 30 from the definitive engagement position P2 to the tentative engagement position P1 by pulling out the operation portion 37 toward the one end portion side (the connector 1 side) in the axis line direction X in a state in which the operation portion 37 is pinched, for example. In addition, the definitive engagement portion 25b and the first protruding portion 33 are provided with an inclined surface for guiding the movement of the fitting assuring member 30 from the definitive engagement position P2 to the tentative engagement position P1.

On the other hand, in the present embodiment, when a fitted state of the housing 20 and the counterpart housing 120 is the half-fitted state (i.e., in a state before the definitive engagement portion 25b gets over the lock engagement portion 122 (refer to FIGS. 6 and 8), an engaged state of the first protruding portion 33 and the definitive engagement portion 25b is held. Accordingly, the fitting assuring member 30 becomes relatively immovable from the tentative engagement position P1 with respect to the housing 20. Specifically, the fitting assuring member 30 is configured to be relatively immovable along the axis line direction X within a range between the above-described tentative engagement portion 25c (refer to FIGS. 7 and 9) provided in the housing lock 25, and the above-described definitive engagement portion 25b (refer to FIGS. 6 and 8).

As described above, in the connector 1 and the wire harness WH of the present embodiment, the tentative engagement portion 25c is provided with the inclined surface 25cl inclined with respect to the axis line direction X, and by the tentative engagement portion 25c inclining in accordance with elastic deformation of the lock arm portion 25a that is caused when the definitive engagement portion 25b gets over the lock engagement portion 122, the second protruding portion 34 runs onto the inclined surface 25cl of the tentative engagement portion 25c, and the fitting assuring member 30 is configured to be able to retract toward the opposite side to the definitive engagement portion 25b along the axis line direction X. With this configuration, in the connector 1 and the wire harness WH, because the distance L1 along the axis line direction X from the proximal end portion 25al (fulcrum point portion) of the lock arm portion 25a up to the contact portion 32 becomes shorter by the fitting assuring member 30 retracting, for example, it is possible to reduce elastic restoring force (reactive force) of the fitting assuring arm portion 31 that acts on the definitive engagement portion 25b from the contact portion 32, and eventually reduce elastic restoring force (reactive force) of the lock arm portion 25a that acts on the lock engagement portion 122 from the definitive engagement portion 25b. Consequently, the connector 1 and the wire harness WH can enhance workability of a fitting work with the counterpart connector 100, workability of a fitting cancel work, and the like.

Further, in the connector 1 and the wire harness WH of the present embodiment, the recess portion 38 with which the definitive engagement portion 25b is to be engaged is provided between the contact portion 32 and the first protruding portion 33, and the definitive engagement portion 25b is positioned with being separated from the first protruding portion 33 along the axis line direction X in the recess portion 38, in a state in which the fitting assuring member 30 is at the tentative engagement position P1 and the lock arm portion 25a has elastically deformed. With this configuration, the connector 1 and the wire harness WH can retract the fitting assuring member 30 along the axis line direction X relatively easily by adjusting a depth of the recess portion 38 that extends along the axis line direction X, an inclination angle of the inclined surface 25cl of the tentative engagement portion 25c, and the like, for example.

Further, in the connector 1 and the wire harness WH of the present embodiment, the first protruding portion 33 is positioned with sandwiching the definitive engagement portion 25b between itself and the lock engagement portion 122, in a state in which the fitting assuring member 30 is at the definitive engagement position P2. With this configuration, for example, by the definitive engagement portion 25b being engaged between the first protruding portion 33 and the lock engagement portion 122, the connector 1 and the wire harness WH can restrict the movement of the connector 1 along the axis line direction X with respect to the counterpart connector 100 and the fitting assuring member 30, and can eventually hold the totally-fitted state of the connector 1 and the counterpart connector 100 more surely.

In addition, in the present embodiment, a case where the housing lock 25 is formed into a cantilever spring shape with respect to the housing main body 21 is exemplified, but the example is not limited to this example, and for example, the housing lock 25 may be formed into a double-supported spring shape with respect to the housing main body 21. Further, in the present embodiment, a case where the connector 1 is formed as a female connector, and the counterpart connector 100 is formed as a male connector is exemplified, but the example is not limited to this example, and for example, the connector 1 may be formed as a male connector and the counterpart connector 100 may be formed as a female connector.

Heretofore, the embodiment of the present invention has been exemplified, but the above-described embodiment is an example, and is not intended to limit the scope of the invention. The above-described embodiment can be implemented in other various configurations, and various omissions, replacements, combinations, and changes can be made without departing from the gist of the invention. Further, the above-described embodiment can be implemented with appropriately changing each configuration and the specification such as shapes (structure, type, direction, format, size, length, width, thickness, height, number, arrangement, position, material, and the like).

In the connector and wire harness according to the present embodiment, by the tentative engagement portion inclining in accordance with elastic deformation of the lock arm portion that is caused when the definitive engagement portion gets over the lock engagement portion, the second protruding portion runs onto the inclined surface of the tentative engagement portion, and the fitting assuring member is configured to be able to retract toward the opposite side to the definitive engagement portion along the axis line direction. With this configuration, in the connector and the wire harness, because a distance along the axis line direction from the proximal end portion (fulcrum point portion) of the lock arm portion up to the contact portion becomes shorter by the fitting assuring member retracting, for example, it is possible to reduce elastic restoring force (reactive force) of the fitting assuring arm portion that acts on the definitive engagement portion from the contact portion, and eventually reduce elastic restoring force (reactive force) of the lock arm portion that acts on the lock engagement portion from the definitive engagement portion. Consequently, the connector and the wire harness bring about an effect that the workability of a fitting work with a counterpart connector can be enhanced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a terminal to be electrically connected with a counterpart terminal of a counterpart connector;
a housing including a housing main body that holds the terminal thereinside, and is to be fitted with a counterpart housing of the counterpart connector along an axis line direction, and a housing lock to be engaged with a lock engagement portion provided in the counterpart housing, along the axis line direction when a fitted state of the housing main body and the counterpart housing is a totally-fitted state; and
a fitting assuring member that is assembled to the housing, while being configured to be relatively immovable from a tentative engagement position with respect to the housing when the fitted state is a half-fitted state, is configured to be relatively movable along the axis line direction between the tentative engagement position and a definitive engagement position with respect to the housing when the fitted state is the totally-fitted state, and assures the totally-fitted state at the definitive engagement position, wherein
the housing lock includes a lock arm portion that extends from the housing main body along the axis line direction and is elastically deformable in a height direction intersecting with the axis line direction, a definitive engagement portion that gets over one end surface in the axis line direction of the lock engagement portion in accordance with a fitting operation of the housing main body provided in the lock arm portion, and the counterpart housing, and is to be engaged with a different end surface in the axis line direction of the lock engagement portion when the fitted state is the totally-fitted state, and a tentative engagement portion provided with being separated from the definitive engagement portion along the axis line direction,
the fitting assuring member includes a fitting assuring arm portion protruding in a cantilever spring shape toward the definitive engagement portion, a contact portion that gets contact with the definitive engagement portion in accordance with elastic deformation of the lock arm portion that is caused when the definitive engagement portion provided at a leading end portion of the fitting assuring arm portion gets over the lock engagement portion, and pushes the definitive engagement portion toward the lock engagement portion side by elastic restoring force of the fitting assuring arm portion, a first protruding portion that is provided at the leading end portion of the fitting assuring arm portion and is to be engaged with the definitive engagement portion at the definitive engagement position, and a second protruding portion that is provided with being separated from the first protruding portion along the axis line direction and is to be engaged with the tentative engagement portion at the tentative engagement position, and
the tentative engagement portion is provided with an inclined surface inclined with respect to the axis line direction, and the second protruding portion runs onto the inclined surface of the tentative engagement portion by the tentative engagement portion inclining in accordance with elastic deformation of the lock arm portion that is caused when the definitive engagement portion gets over the lock engagement portion, and the fitting assuring member is configured to be able to retract along the axis line direction toward an opposite side to the definitive engagement portion.

2. The connector according to claim 1, wherein
a recess portion with which the definitive engagement portion is to be engaged is provided between the contact portion and the first protruding portion, and wherein
the definitive engagement portion is positioned with being separated from the first protruding portion along the axis line direction in the recess portion, in a state in which the fitting assuring member is at the tentative engagement position and the lock arm portion has elastically deformed.

3. The connector according to claim 1, wherein
the first protruding portion is positioned with sandwiching the definitive engagement portion between itself and the lock engagement portion, in a state in which the fitting assuring member is at the definitive engagement position.

4. The connector according to claim 2, wherein
the first protruding portion is positioned with sandwiching the definitive engagement portion between itself and the lock engagement portion, in a state in which the fitting assuring member is at the definitive engagement position.

5. A wire harness comprising:
a wiring material having electrical conductivity; and
a connector provided at an end of the wiring material, wherein
the connector includes
a terminal to be electrically connected with a counterpart terminal of a counterpart connector,
a housing including a housing main body that holds the terminal thereinside, and is to be fitted with a counterpart housing of the counterpart connector along an axis line direction, and a housing lock to be engaged with a lock engagement portion provided in the counterpart housing, along the axis line direction when a fitted state of the housing main body and the counterpart housing is a totally-fitted state, and
a fitting assuring member that is assembled to the housing, while being configured to be relatively immovable from a tentative engagement position with respect to the housing when the fitted state is a half-fitted state, is configured to be relatively movable along the axis line direction between the tentative engagement position and a definitive engagement position with respect to the housing when the fitted state is the totally-fitted state, and assures the totally-fitted state at the definitive engagement position,
the housing lock includes a lock arm portion that extends from the housing main body along the axis line direction and is elastically deformable in a height direction intersecting with the axis line direction, a definitive engagement portion that gets over one end surface in the axis line direction of the lock engagement portion in accordance with a fitting operation of the housing main body provided in the lock arm portion, and the counterpart housing, and is to be engaged with a different end surface in the axis line direction of the lock engagement portion when the fitted state is the totally-fitted state, and a tentative engagement portion provided with being separated from the definitive engagement portion along the axis line direction,
the fitting assuring member includes a fitting assuring arm portion protruding in a cantilever spring shape toward the definitive engagement portion, a contact portion that gets contact with the definitive engagement portion in accordance with elastic deformation of the lock arm portion that is caused when the definitive engagement portion provided at a leading end portion of the fitting assuring arm portion gets over the lock engagement portion, and pushes the definitive engagement portion toward the lock engagement portion side by elastic restoring force of the fitting assuring arm portion, a first protruding portion that is provided at the leading end portion of the fitting assuring arm portion and is to be engaged with the definitive engagement portion at the definitive engagement position, and a second protruding portion that is provided with being separated from the first protruding portion along the axis line direction and is to be engaged with the tentative engagement portion at the tentative engagement position, and
the tentative engagement portion is provided with an inclined surface inclined with respect to the axis line direction, and the second protruding portion runs onto the inclined surface of the tentative engagement portion by the tentative engagement portion inclining in accordance with elastic deformation of the lock arm portion that is caused when the definitive engagement portion gets over the lock engagement portion, and the fitting assuring member is configured to be able to retract along the axis line direction toward an opposite side to the definitive engagement portion.
